(19) United States
(12) Patent Application Publication
(10) Pub. No.: US 2019/0166977 A1
(43) Pub. Date: Jun. 6, 2019

(54) COMPACT CONTAINER HAVING RING BUTTON MEMBER PROVIDED THEREON AND HAVING DISCHARGE PLATE FORMED THROUGH INSERT INJECTION MOLDING

(71) Applicant: PUM-TECH KOREA CO., LTD, Incheon (KR)

(72) Inventor: Do Hoon LEE, Incheon (KR)

(21) Appl. No.: 16/319,785

(22) PCT Filed: Jul. 25, 2017
(86) PCT No.: PCT/KR2017/007983

§ 371 Date: Jan. 22, 2019

(30) Foreign Application Priority Data
Jul. 28, 2016 (KR) 10-2016-0095867
Dec. 13, 2016 (KR) 10-2016-0169643

(51) Int. Cl. A45D 40/00; B29C 45/14; B65D 83/00

(52) U.S. Cl. CPC A45D 40/0075; B29L 2031/718; B65D 83/0038; B29C 45/14467

(57) ABSTRACT

The present invention relates to a compact container having a ring button member provided thereon and having a discharge plate formed by insert injection molding, wherein a discharge means is installed inside the compact container to discharge a cosmetic material; a ring button member is coupled to the outside of the pallet; a pair of compression grooves are formed on the inner peripheral edge of the ring button member; a pair of compression protrusions are formed on the outer peripheral edge of the pallet and are inserted into the compression grooves; pallets are formed on the upper portion of the discharge means; and a discharge plate is formed as a single component through insert injection molding between the upper pallet and the lower pallet of the pallets

### CROSS-REFERENCE TO RELATED APPLICATIONS

This application is based on and claims the benefit of priority to Korean Patent Application No. 10-2016-0095867 filed on Jul. 28, 2016 and Korean Patent Application No. 10-2016-0169643 filed on Dec. 13, 2016, with the Korean Intellectual Property Office, the disclosure of which is incorporated herein by reference.

### TECHNICAL FIELD

The present invention relates to a compact container having a ring button member provided thereon and having a discharge plate formed by insert injection molding, and more particularly, to a compact container having a ring button member provided thereon and having a discharge plate formed by insert injection molding, wherein a discharge device is installed inside the compact container to discharge a cosmetic material, pallets for pressurizing the discharge device are provided, and the discharge plate is formed as a single component between an upper pallet and a lower pallet of the pallets through the insert injection molding, so that an assembly process for separately coupling the discharge plate and the upper/lower pallets to the compact container is removed so as to improve productivity, and a defective product is prevented from occurring in the process of assembling the discharge plate and the upper/lower pallets.

### BACKGROUND ART

In general, makeup is for making a beautiful part of a body more beautiful, and for compensating for a weak point of the body. Women put on facial makeup by using basic cosmetics or color cosmetics to make their appearance more beautiful.

The color cosmetics are classified into a base makeup used for making a skin color uniform and covering defects, and a point makeup used for partially enhancing a three-dimensional effect of lips, eyes, or nails. The base makeup includes a makeup base, a foundation, and a powder, and the point makeup includes a lipstick, an eye liner, and mascara.

The foundation is classified into a solid foundation, a liquid foundation and a gel foundation according to the form of the cosmetic material. Although the solid foundation produces an effect of excellently covering the skin, the solid foundation may be agglomerated when correcting the makeup. In addition, although the liquid foundation provides a good close contact feel, the persistency of the liquid foundation is weak.

Thus, in recent years, the gel foundation, which gives fresh feelings upon use by imparting a feeling of lightness and moisture, is increasingly used.

However, in case of filling the gel foundation in a typical container for use, the same amount of cosmetic materials may not be used every time the makeup is performed, and the cosmetic materials are contaminated with bacteria and wastes because a hand of a user or a puff repeatedly makes contact with the cosmetic materials.

To solve the problems described above, as shown in FIG. 1, there is provided Korean Patent No. 10-1566114 which discloses a cosmetic container. The related art includes a discharge device for discharging a cosmetic product to an outside, and a discharge plate provided at one side of the discharge device where the cosmetic product is discharged from the discharge device, having at least one discharge port, and exposed to the outside to allow a puff of a user to make contact with the discharge plate, wherein the cosmetic product is discharged from the discharge device as the discharge plate is pressed.

The related art further includes a sealing member or a packing material closely interposed between a dispersion part and the discharge plate, so that the cosmetic product may be prevented from leaking to a part other than the discharge port of the discharge plate.

However, in the related art, when a center of the discharge plate is not pressed, an up-down movement member is inclined and caught in an inner periphery of the sealing member. Accordingly, a cosmetic material is pumped only when the user presses a center part of the discharge plate vertically, so that a pressing position is limited when pressing the discharge plate, which causes inconvenience in use.

In addition, since the related art has a structure that the sealing member or the packing material is coupled between a guide plate and the discharge plate to prevent the leakage of the cosmetic products, productivity is decreased due to an increase in an assembly process during production of products, and defective products occur in the assembly process.

### DISCLOSURE

### Technical Problem

To solve the problems described above, the present invention provides a compact container having a ring button member provided thereon and having a discharge plate formed by insert injection molding, wherein a discharge device is installed inside the compact container to discharge a cosmetic material, pallets for pressurizing the discharge device are provided, and the discharge plate is formed as a single component between an upper pallet and a lower pallet of the pallets through the insert injection molding, so that an assembly process for separately coupling the discharge plate and the upper/lower pallets to the compact container is removed so as to improve productivity, and a defective product is prevented from occurring in the process of assembling the discharge plate and the upper/lower pallets.

In addition, the present invention provides a compact container having a ring button member provided thereon and having a discharge plate formed by insert injection molding, wherein a fusion groove is formed in a lower portion of the upper pallet of the pallets, and a fusion protrusion part corresponding to the fusion groove is provided on an upper outer side of the lower pallet, such that a fusing surface of the upper pallet and the lower pallet is widened, and the upper pallet is insert-injection-molded while surrounding an outer side of the lower pallet, so that the upper pallet and the lower pallet are fused to each other without being separated from each other, and a cosmetic material is prevented from leaking between the upper and lower pallets and the discharge plate.

### Technical Solution

The present invention provides a compact container having a ring button member provided thereon and having a discharge plate formed through insert injection molding, in which the compact container includes an outer container, an outer container lid hinge-coupled to one side of the outer container so as to be opened and closed, and an inner container mounted inside the outer container, the compact container including:

a discharge device installed in the inner container to discharge a cosmetic material;

a pallet coupled to the discharge device to pressurize the discharge device; and

a ring button member coupled to the pallet to pressurize the pallet,

wherein the pallet includes an upper pallet and a lower pallet, in which a discharge plate having a discharge port is formed between the upper pallet and the lower pallet through the insert injection molding, and

the upper pallet is insert-injection-molded while surrounding an outer side of the lower pallet such that the upper pallet and the lower pallet are fused to each other.

In addition, the discharge device may be a pump for pumping the cosmetic material.

In addition, a support part may be formed at a center of the lower pallet to make close contact with a bottom of the discharge plate.

In addition, the lower pallet may be provided with a seating part on which the discharge plate is seated.

In addition, a distribution passage may be formed in the lower pallet to allow the cosmetic material to be spread widely.

In addition, a mesh net may be provided on an upper portion of the distribution passage.

In addition, a covering length of the upper pallet for an upper outer side of the discharge plate is preferably 0.5 mm to 2.0 mm.

In addition, a height from a top surface of the discharge plate to an inner end of the upper pallet is preferably 0.3 mm to 1.5 mm.

In addition, a height from a top surface of the discharge plate to a top surface of the upper pallet is preferably 1.5 mm to 5.5 mm.

In addition, a fusion groove may be formed in a lower portion of the upper pallet, and a fusion protrusion part may be provided on an upper outer side of the lower pallet, such that the fusion groove and the fusion protrusion part are fused to each other.

In addition, the discharge plate may be formed of a metal, an alloy of metal, or a plated metal.

In addition, the discharge plate may be formed of a stainless steel material among metal materials.

In addition, the discharge plate may be formed of a synthetic resin or a fiber material.

### Advantageous Effects

In the compact container having the ring button member provided thereon and having the discharge plate formed by the insert injection molding according to the present invention, the discharge device is installed inside the compact container to discharge the cosmetic material, the pallets for pressurizing the discharge device are provided, and the discharge plate is formed as a single component between the upper pallet and the lower pallet of the pallets through the insert injection molding, so that the assembly process for separately coupling the discharge plate and the upper/lower pallets to the compact container can be removed so as to improve the productivity, and a defective product can be prevented from occurring in the process of assembling the discharge plate and the upper/lower pallets.

In addition, in the compact container having the ring button member provided thereon and having the discharge plate formed by the insert injection molding according to the present invention, the fusion groove is formed in the lower portion of the upper pallet of the pallets, and the fusion protrusion part corresponding to the fusion groove is provided on the upper outer side of the lower pallet, such that the fusing surface of the upper pallet and the lower pallet is widened, and the upper pallet is insert-injection-molded while surrounding the outer side of the lower pallet, so that the upper pallet and the lower pallet are fused to each other without being separated from each other, and the cosmetic material is prevented from leaking between the upper and lower pallets and the discharge plate.

### DESCRIPTION OF DRAWINGS

FIG. 1 shows a conventional cosmetic container.

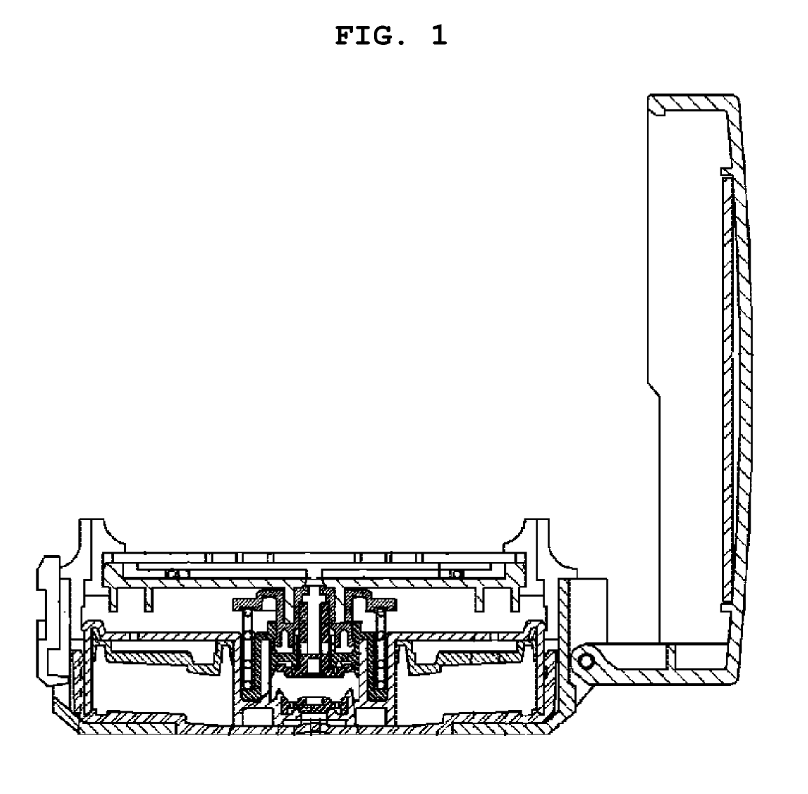

FIG. 2 is a perspective view showing a compact container having a ring button member provided thereon and having a discharge plate formed through insert injection molding according to the present invention.

FIG. 3 is an exploded perspective view showing the compact container having the ring button member provided thereon and having the discharge plate formed through the insert injection molding according to the present invention.

FIG. 4 is a sectional view taken along line B-B of the compact container having the ring button member provided thereon and having the discharge plate formed through the insert injection molding according to the present invention.

FIG. 5 is a sectional view taken along line A-A of the compact container having the ring button member provided thereon and having the discharge plate formed through the insert injection molding according to the present invention.

FIG. 6 is a partial perspective view and partial sectional view showing a pallet of the compact container having the ring button member provided thereon and having the discharge plate formed through the insert injection molding according to the present invention.

FIG. 7 is a sectional view taken along line A-A representing that a cosmetic material is discharged by pressing the ring button member of the compact container having the ring button member provided thereon and having the discharge plate formed through the insert injection molding according to the present invention.

FIG. 8 is a sectional view taken along line A-A representing that the cosmetic material is sucked into a discharge device as the ring button member ascends in the compact container having the ring button member provided thereon and having the discharge plate formed through the insert injection molding according to the present invention.

FIG. 9 is a partial sectional view showing a mesh net provided on an upper portion of a distribution passage of the compact container having the ring button member provided thereon and having the discharge plate formed through the insert injection molding according to the present invention.

### BEST MODE

### Mode for Invention

The technical objects achieved by the present invention and the implementation of the present invention will be more clearly understood by the following description of preferred embodiments. Hereinafter, a compact container having a ring button member provided thereon and having a discharge plate formed through insert injection molding according to one embodiment of the present invention will be described with reference to the accompanying drawings.

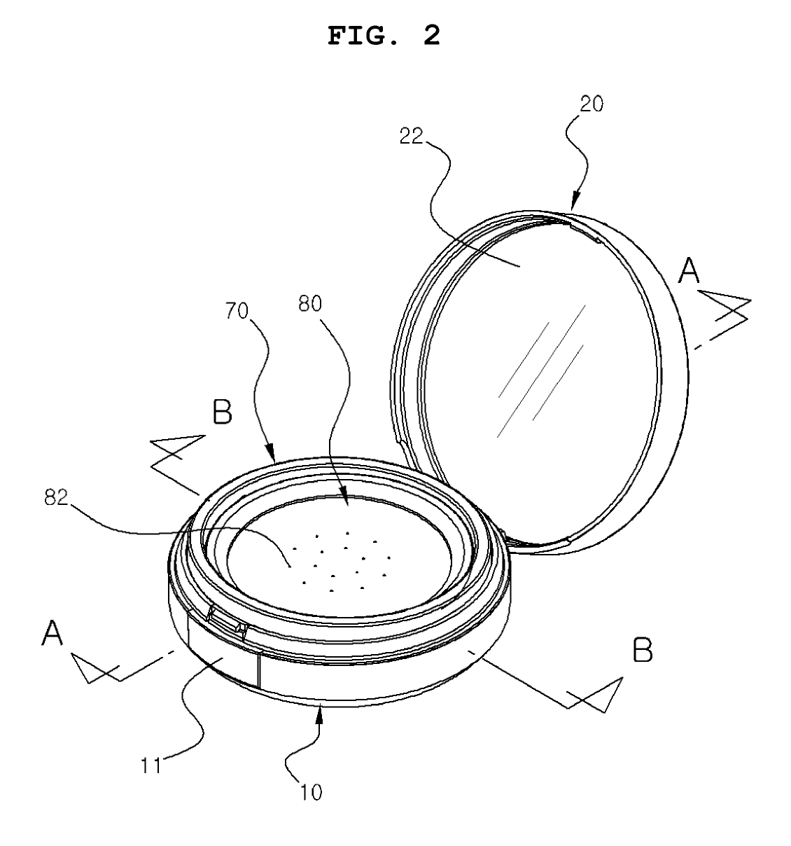

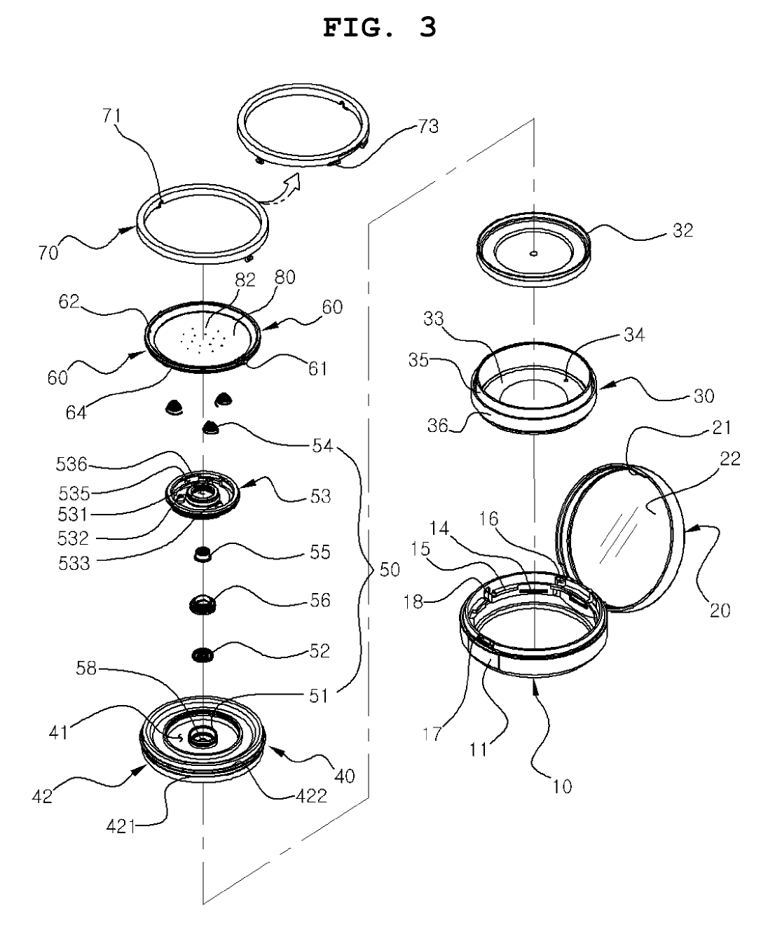

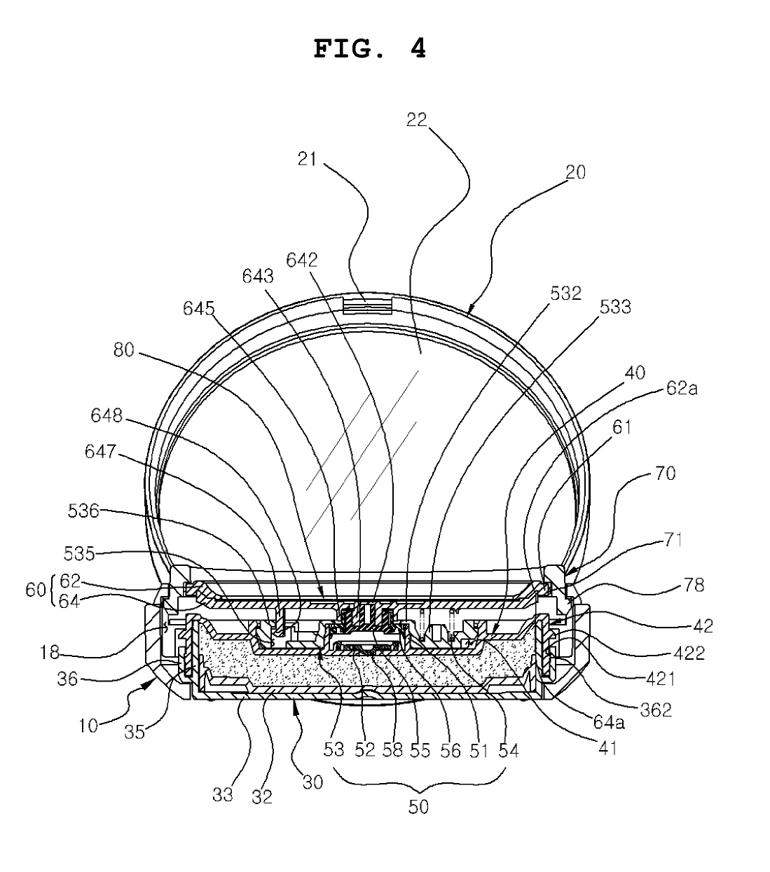

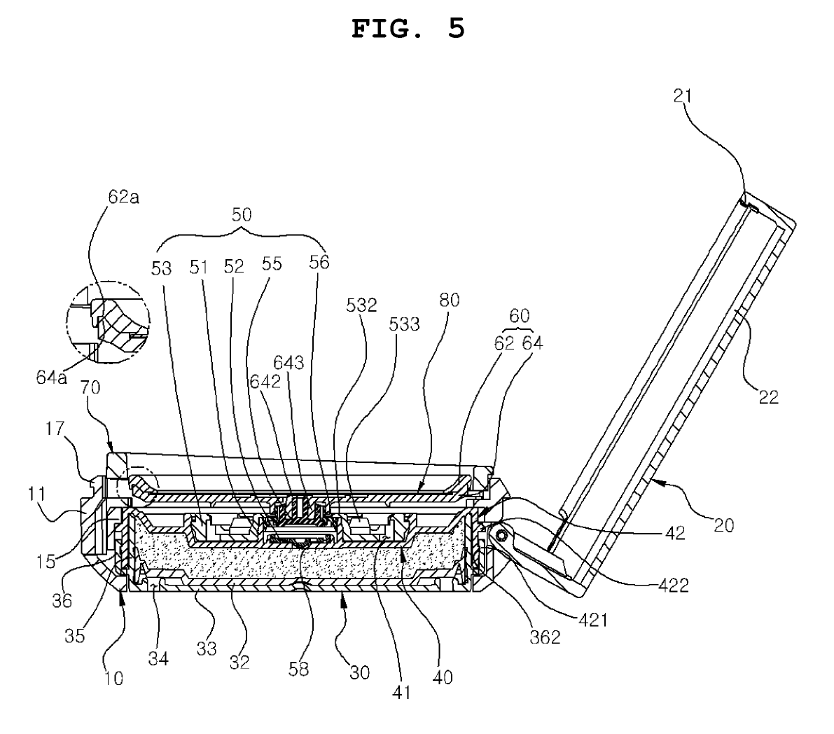

FIG. 2 is a perspective view showing a compact container having a ring button member provided thereon and having a discharge plate formed through insert injection molding according to the present invention, FIG. 3 is an exploded perspective view showing the compact container having the ring button member provided thereon and having the discharge plate formed through the insert injection molding according to the present invention, FIG. 4 is a sectional view taken along line B-B of the compact container having the ring button member provided thereon and having the discharge plate formed through the insert injection molding according to the present invention, and FIG. 5 is a sectional view taken along line A-A of the compact container having the ring button member provided thereon and having the discharge plate formed through the insert injection molding according to the present invention.

According to the present invention, as shown in FIGS. 2 to 5, a compact container having a ring button member provided thereon and having a discharge plate formed through insert injection molding, in which the compact container includes an outer container 10, an outer container lid 20 hinge-coupled to one side of the outer container 10 so as to be opened and closed, and an inner container 30 mounted inside the outer container 10, includes: a discharge device 50 for discharging a cosmetic material; a pallet 60 coupled to the discharge device 50 to pressurize the discharge device 50; and a ring button member 70 coupled to the pallet 60 to pressurize the pallet 60, wherein the pallet 60 includes an upper pallet 62 and a lower pallet 64, in which a discharge plate 80 having a discharge port 82 is formed between the upper pallet 62 and the lower pallet 64 through the insert injection molding, and the upper pallet 62 is insert-injection-molded while surrounding an outer side of the lower pallet 64 such that the upper pallet 62 and the lower pallet 64 are fused to each other.

The inner container 30 is mounted inside the outer container 10, and first and second mounting protrusions 14 and 15 protrude from an inner side surface of the outer container 10.

A pair of fastening grooves 18 coupled to fastening protrusions 78 of the ring button member 70 are formed in an inner periphery of the outer container 10.

A button 11 is formed on one side of the outer container 10, and a latching protrusion 17 protrudes from a top of the button 11.

In addition, an axial coupling groove 16 is formed on the inner side surface of the outer container 10 facing the button 11.

The outer container lid 20 opens and closes the outer container 10, and a hook 21 having a protrusion shape is provided on one side of the outer container lid 20 at a position corresponding to the latching protrusion 17 of the button 11 so as to be fastened to the latching protrusion 17 of the button 11.

In addition, a mirror 22 may be provided at an inner side of the outer container lid 20 so that a user may easily perform makeup.

A liquid or gel cosmetic material is accommodated in the inner container 30.

The inner container 30 is provided at an inner side thereof with a push plate 32 for pushing the cosmetic material upward, and the push plate 32 makes close contact with an inner side surface of the inner container 30.

The inner container 30 includes an inner container bottom surface 33, an inner wall 35 extending upward from the inner container bottom surface 33, and an outer wall 36 spaced outward from the inner wall 35 by a predetermined distance.

A coupling groove 362 is formed in an inner periphery of the outer wall 36 of the inner container 30.

In addition, the inner container bottom surface 33 of the inner container 30 is formed with an air passage hole 34 through which external air is introduced.

In addition, a discharge device support 40 having a plate shape is coupled to an upper portion of the inner container 30, in which the discharge device support 40 is coupled to the upper portion of the inner container 30, and the discharge device 50 is installed on an upper portion of the discharge device support 40.

A cylinder 51 is provided at a center of the discharge device support 40, a bushing coupling groove 41 to which a bushing 53 of the discharge device 50 is coupled is formed at an outer side of the cylinder 51, and a lower extension protrusion wheel 42 extends downward from an outer side of the discharge device support 40.

In the drawings of the present invention, it is shown that the cylinder 51 is integrally formed at the center of the discharge device support 40, so that the bushing 53 is installed on the outer side of the cylinder 51 to prevent a piston 55 fitted with a piston ring 56 from being separated from the cylinder 51, and an inner horizontal extension piece 532 is formed inward of a through-hole 531 of the bushing 53. However, the discharge device support 40 and the cylinder 51 may be separately formed, and the discharge device 50 may be provided at the center of the discharge device support 40. In this case, the bushing 53 described in the present invention may not be required.

A coupling protrusion 421 is formed on an outer periphery of the lower extension protrusion wheel 42 of the discharge device support 40 so as to be coupled to the coupling groove 362 of the inner container 30, and a mounting protrusion wheel 422 protrudes from a top of the coupling protrusion 421 so as to be fitted between the first and second mounting protrusions 14 and 15 of the outer container 10.

The discharge device 50 is installed on the discharge device support 40 to discharge the cosmetic material accommodated in the inner container 30 to an outside.

The discharge device 50 may be a pump for pumping the cosmetic material accommodated in the inner container 30.

The discharge device 50 may include the cylinder 51 formed at the center of the discharge device support 40 and formed on a bottom surface thereof with a content suction hole 58, a suction valve plate 52 mounted on a bottom surface of the cylinder 51 to selectively open and close the content suction hole 58, the bushing 53 placed on an upper end of the cylinder 51 and coupled to the outer side of the cylinder 51, an elastic member 54 mounted on an upper portion of the bushing 53 or the upper portion of the discharge device support 40 to elastically support the pallet 60, the piston 55 provided at an inner side of the cylinder 51, and the piston ring 56 fitted on the outer side of the piston 55 while making close contact with an inner side surface of the cylinder 51.

The through-hole 531 through which the piston 55 and the piston ring 56 pass is formed at a center of the bushing 53, the inner horizontal extension piece 532 extends inward of the through-hole 531, and a plurality of elastic member mounting parts 533 are provided at an outer side of the through-hole 531.

The bushing 53 is provided with a first latching sill 536 to which an anti-separation part 647 of the pallet 60 is coupled, and the first latching sill 536 serves to prevent the pallet 60 from being separated from the discharge device 50.

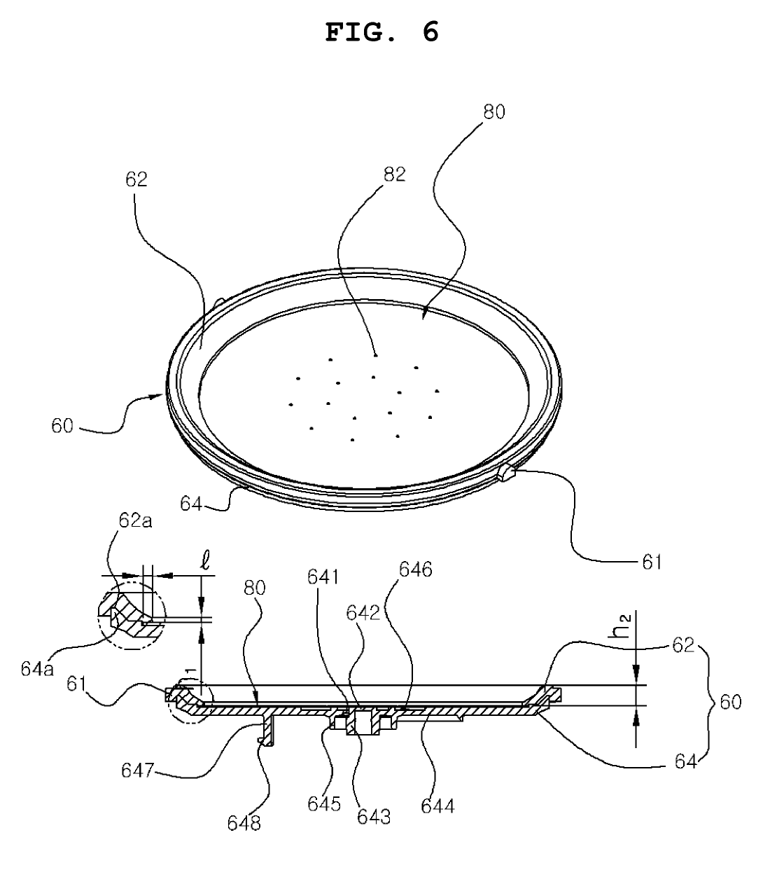

FIG. 6 is a partial perspective view and partial sectional view showing a pallet of the compact container having the ring button member provided thereon and having the discharge plate formed through the insert injection molding according to the present invention.

The pallet 60 is coupled to an upper portion of the discharge device 50 to fix the discharge plate 80 and to vertically move so as to pressurize the discharge device 50.

A pair of compression protrusions 61 facing each other in a diagonal direction are formed on an outer periphery of the pallet 60, in which the compression protrusions 61 of the pallet 60 are formed to correspond to positions of compression grooves 71 of the ring button member 70 so as to be fitted to the compression grooves 71 of the ring button member 70, respectively.

The compression protrusion 61 of the pallet 60 has a semicircular or circular shape so that the compression protrusion 61 may be easily rotated within the compression groove 71 of the ring button member 70.

As shown in FIG. 6, the pallet 60 includes the upper pallet 62 and the lower pallet 64, in which the discharge plate 80 is insert-injection-molded between the upper pallet 62 and the lower pallet 64.

In addition, a bottom surface of the upper pallet 62 and a top surface of the lower pallet 64 are integrally fused to each other at an outer side of the discharge plate 80 through the insert injection molding.

In other words, after the lower pallet 64 is injection-molded, the discharge plate 80 is seated on a support part 642 and a seating part 644 of the lower pallet 64, and the upper pallet 62 is injection-molded, so that the lower pallet 64 and the upper pallet 62 may be integrally fused to each other at the outer side of the discharge plate 80.

Therefore, when the compact container is assembled, a process of assembling the discharge plate 80 and the upper and lower pallets 62 and 64 may be reduced so as to improve productivity, and the cosmetic material discharged by the discharge device 80 may be prevented from leaking between the upper pallet 62 and the lower pallet 64.

In addition, as shown in FIG. 5, in the compact container according to the present invention, a fusion groove 62a is formed in a lower portion of the upper pallet 62, and a fusion protrusion part 64a corresponding to the fusion groove 62a is provided on an upper outer side of the lower pallet 64, such that a fusing surface of the upper pallet 62 and the lower pallet 64 is widened, and the upper pallet 62 is insert-injection-molded while surrounding an outer side of the lower pallet 64. Accordingly, the upper pallet 62 and the lower pallet 64 are completely fused to each other without being separated from each other.

As shown in FIG. 6, when the upper pallet 62 is insert-injection-molded with the discharge plate 80, a covering length l of the upper pallet 62 for an upper outer side of the discharge plate 80 is about 0.5 mm to 2.0 mm. In a case where the upper pallet 62 covers the upper outer side of the discharge plate 80 by less than 0.5 mm, a covering area of the upper pallet 62 for a top surface of the discharge plate 80 is small, so that the discharge plate 80 is not firmly fixed to the pallet 60, causing the upper discharge plate to be separated upward. In addition, in a case where the upper pallet 62 covers the upper outer side of the discharge plate 80 by more than 2.0 mm, a covering area of the upper pallet 62 for the top surface of the discharge plate 80 is widened, so that utilization of space over the top surface of the discharge plate 80 becomes inefficient.

An inner end of the upper pallet 62 has a stepped configuration, and, as shown in FIG. 6, a height h1 from the top surface of the discharge plate 80 to the inner end of the upper pallet 62 is preferably 0.3 mm to 1.5 mm.

In a case where the height h1 from the top surface of the discharge plate 80 to the inner end of the upper pallet 62 is less than 0.3 mm, an end portion of the upper pallet 62 is too thin, so that the inner end of the upper pallet 62 may be easily broken even in a minute impact during a manufacturing process or when distributed and carried. In addition, in a case where the height h1 from the top surface of the discharge plate 80 to the inner end of the upper pallet 62 exceeds 1.5 mm, when the cosmetic material discharged onto the top surface of the discharge plate 80 is put on a puff while being rubbed with the puff, the cosmetic material may be contaminated since the cosmetic material caught in an edge groove between the top surface of the discharge plate 80 and the inner end of the upper pallet 62 so as to remain in the edge groove.

In addition, a height h2 from the top surface of the discharge plate 80 to a top surface of the upper pallet 62 is 1.5 mm to 5.5 mm. In a case where the height h2 of the upper pallet 62 is less than 1.5 mm, when the cosmetic material discharged onto the top surface of the discharge plate 80 is put on the puff while being rubbed with the puff, the cosmetic material may go over the upper pallet 62 so as to fall between the upper pallet 62 and the ring button member 70, so that an inside of the compact container may be contaminated. In a case where the height h2 exceeds 5.5 mm, a thickness of the compact container becomes large due to the height h2 of the upper pallet 62, resulting in reduced portability.

In addition, the support part 642 for supporting the discharge plate 80 so that the discharge plate 80 is not bent when the discharge plate 80 is pressed is integrally formed at a center of the lower pallet 64, in which a top surface of the support part 642 makes close contact with a central bottom surface of the discharge plate 80.

The lower pallet 64 is formed at the outer side thereof with a discharge passage 641 through which the cosmetic material discharged by the discharge device 50 passes.

A first lower extension protrusion wheel 643 extends from a bottom of the support part 642 of the lower pallet 64, and the first lower extension protrusion wheel 643 is coupled to the piston 55 of the discharge device 50.

A second lower extension protrusion wheel 645 fitted to an outer side of the piston ring 56 of the discharge device 50 extends downward while being spaced outward from the first lower extension protrusion wheel 643 of the lower pallet 64 by a predetermined distance.

The anti-separation part 647 for preventing the pallet 60 from being separated from the compact container extends downward from an outer side of the second lower extension protrusion wheel 645 of the lower pallet 64, in which a second latching sill 648 is formed at a bottom of the anti-separation part 647 so as to be fastened to the first latching sill 536 of the bushing 53.

A distribution passage 646 is formed in an upper portion of the lower pallet 64 to allow the cosmetic material which has passed through the discharge passage 641 to be spread widely, and the distribution passage 646 is provided at an outer side thereof with a seating part 644 on which the discharge plate 80 is seated.

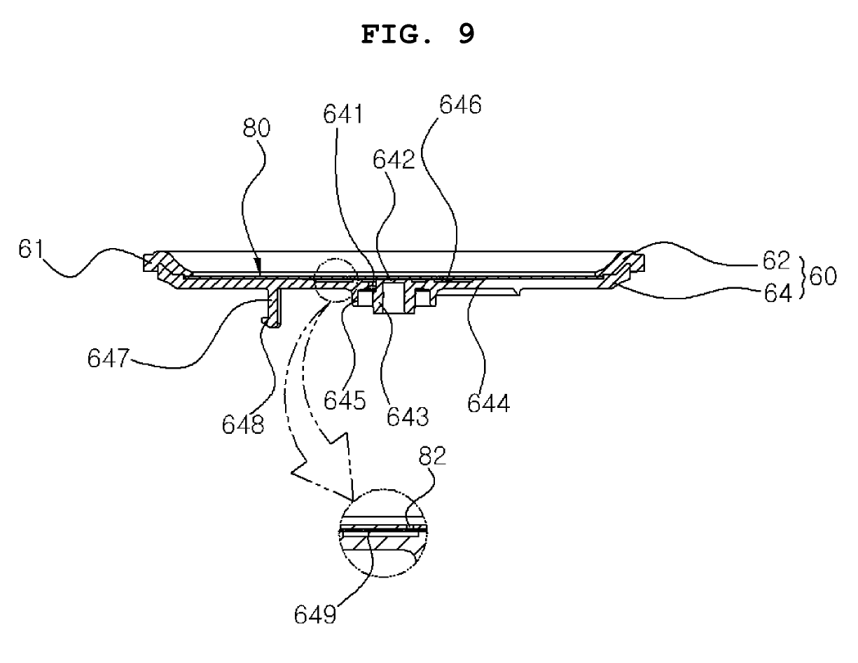

FIG. 9 is a partial sectional view showing a mesh net provided on an upper portion of a distribution passage of the compact container having the ring button member provided thereon and having the discharge plate formed through the insert injection molding according to the present invention.

As shown in FIG. 9, a mesh net 649 may be provided on an upper portion of the distribution passage 646 of the lower pallet 64, in which the mesh net 649 allows the cosmetic material pumped by the discharge device 50 to be discharged as fine particles without being agglomerated.

The upper pallet 62 may have a ring shape such that the top surface of the discharge plate 80 is exposed to the outside.

The ring button member 70 has a ring shape, is coupled to an outer side of the pallet 60, and is formed at an inner periphery thereof with a pair of compression grooves 71 facing each other in a diagonal direction.

The fastening protrusion 78 protrudes outward from an outer periphery of the ring button member 70 on an opposite side of the compression groove 71, in which the fastening protrusion 78 is fitted to the fastening groove 18 of the outer container 10 to prevent the ring button member 70 from being separated from the outer container 10.

An axial protrusion 73 is formed on one side of the outer periphery of the ring button member 70 so as to be fitted to the axial coupling groove 16 of the outer container 10.

The compression groove 71 of the ring button member 70 has a semicircular or polygonal shape.

A diameter of the compression protrusion 61 of the pallet 60 is smaller than an inner diameter of the compression groove 71 of the ring button member 70.

In other words, the compression protrusion 61 of the pallet 60 has a semicircular or circular shape, the compression groove 71 of the ring button member 70 has a semicircular shape, and the diameter of the compression protrusion 61 is smaller than the inner diameter of the compression groove 71 so as to allow the compression protrusion 61 to be fitted to the compression groove 71. Therefore, when the user pressurizes the ring button member 70 or the discharge plate 80 to discharge the cosmetic material, even if the ring button member 70 or the discharge plate 80 is pressurized in an inclined state, the compression groove 71 of the ring button member 70 is idly rotated at an upper portion of the compression protrusion 61 of the pallet 60 so that a center of pressurization may be changed, and thus, the pallet 60 may vertically pressurize the discharge device 50.

The discharge plate 80 is insert-injection-molded between the upper pallet 62 and the lower pallet 64 of the pallet 60.

The discharge plate 80 is formed with a plurality of discharge ports 82 for discharging the cosmetic material pumped by the discharge device 50 to the outside.

The discharge plate 80 may be formed of a metal, a synthetic resin, or a fiber material.

When the discharge plate 80 is formed of a synthetic resin material, the discharge plate 80 is preferably formed of at least one material among an epoxy resin, an amino resin, a phenol resin, polyester, polyethylene, an acrylic resin, polypropylene, polystyrene, polyvinyl chloride, Teflon, nylon, and a polyacetal resin.

In addition, the discharge plate 80 may be formed of various materials such as a metal alloy and a plated metal.

When the discharge plate 80 is formed of a metal material, the discharge plate 80 may be formed of at least one material among iron (Fe), aluminum (Al), copper (Cu), tungsten (W), stainless steel, nickel (Ni), tin (Sn), titanium (Ti), zinc (Zn), and gallium (Ga).

The discharge plate 80 may be formed of stainless steel, which is a material of SUS 304 among SUS 300 series having excellent corrosion resistance, acid resistance, and thermal resistance. In particular, the discharge plate 80 may be formed of a material of 304J1 to improve antibacterial and hygienic properties.

However, the present embodiment does not limit a material of a metal plate 10 to those described above, and the metal plate 10 may be formed of at least one material among 301L, 304L, 304LN, 304N1, 305EG, 309S, 310S, 316, 316L, 316LN, 316Ti, 317L, 321, 347, 329J3L, and 329LD, including 304 series.

Hereinafter, a method of assembling the compact container having the ring button member provided thereon and having the discharge plate formed through the insert injection molding, which has a configuration as described above, will be described with reference to the accompanying drawings.

In order to assemble the compact container having the ring button member provided thereon and having the discharge plate formed through the insert injection molding according to the present invention, first, as shown in FIGS. 3 to 5, the inner container 30 is mounted inside the outer container 10 having one side hinge-coupled with the outer container lid 20.

Next, the push plate 32 is fitted into the inner container 30, the cosmetic material is injected into the inner container 30, and the discharge device support 40 is coupled to the upper portion of the inner container 30, such that the lower extension protrusion wheel 42 of the discharge device support 40 is fitted between the inner wall 35 and the outer wall 36 of the inner container 30 while the mounting protrusion wheel 422 of the lower extension protrusion wheel 42 is fitted between the first and second mounting protrusions 14 and 15 of the outer container 10.

Then, the discharge device 50 is installed on the discharge device support 40, and the pallet 60 is coupled to the upper portion of the discharge device 50, such that the anti-separation part 647 of the pallet 60 is inserted into an anti-separation part insertion groove 535 of the discharge device 50, and the second latching sill 648 of the anti-separation part 647 is fastened to the first latching sill 536 of the discharge device 50.

At the same time, the first lower extension protrusion wheel 643 and the second lower extension protrusion wheel 645 of the pallet 60 are coupled to the piston 55 and the piston ring 56 of the discharge device 50, respectively.

At this time, the bottom surface of the upper pallet 62 and the top surface of the lower pallet 64 are integrally fused to each other at the outer side of the discharge plate 80 through the insert injection molding, and the central bottom surface of the discharge plate 80 makes close contact with the support part 642 of the lower pallet 64.

Finally, the ring button member 70 is mounted on an upper portion of the pallet 60, in which the compression protrusion 61 of the pallet 60 and the compression groove 71 of the ring button member 70 are aligned in positions thereof, the axial protrusion 73 of the ring button member 70 is fitted to the axial coupling groove 16 of the outer container 10, and the fastening protrusion 78 of the ring button member 70 is fitted to the fastening groove 18 of the outer container 10, thereby completely assembling the compact container having the ring button member provided thereon and having the discharge plate formed through the insert injection molding according to the present invention.

Hereinafter, the use of the compact container having the ring button member provided thereon and having the discharge plate formed through the insert injection molding, which is assembled as described above, will be described.

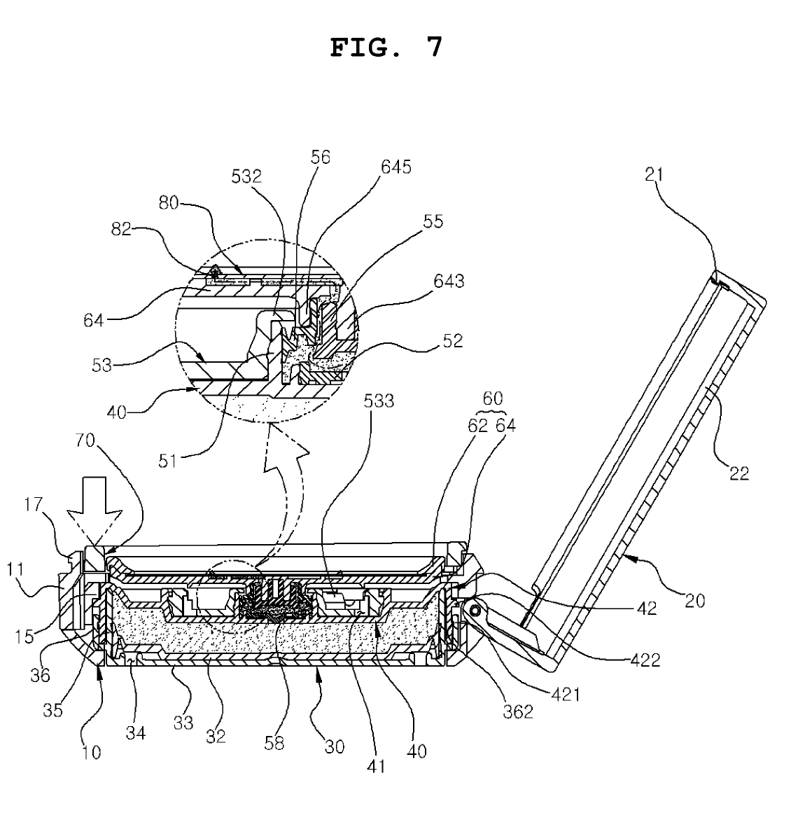

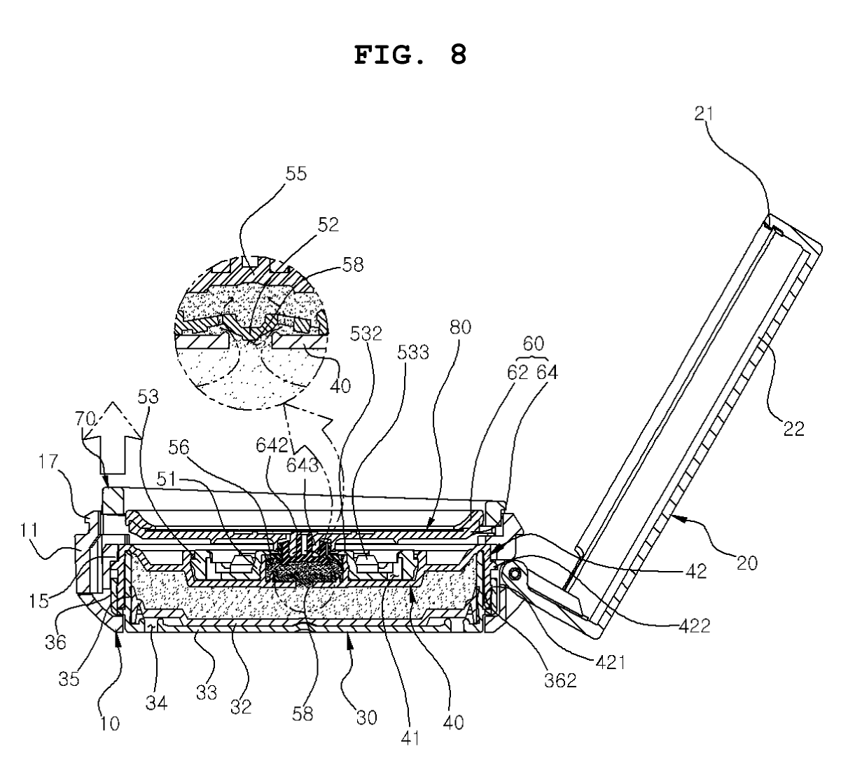

FIG. 7 is a sectional view taken along line A-A representing that a cosmetic material is discharged by pressing the ring button member of the compact container having the ring button member provided thereon and having the discharge plate formed through the insert injection molding according to the present invention, and FIG. 8 is a sectional view taken along line A-A representing that the cosmetic material is sucked into a discharge device as the ring button member ascends in the compact container having the ring button member provided thereon and having the discharge plate formed through the insert injection molding according to the present invention.

In order to use the compact container having the ring button member provided thereon and having the discharge plate formed through the insert injection molding according to the present invention, first, as shown in FIG. 7, the outer container lid 20 is opened, and a top surface of the ring button member 70 is pressurized.

When the ring button member 70 is pressurized, the ring button member 70 is inclined so as to move downward, and the pallet 60 mounted on a lower side of the ring button member 70 is moved downward together with the ring button member 70.

In this case, the compression protrusion 61 of the pallet 60 has a semicircular or circular shape, the compression groove 71 of the ring button member 70 has a semicircular shape, and the diameter of the compression protrusion 61 is smaller than the inner diameter of the compression groove 71 so as to allow the compression protrusion 61 to be fitted to the compression groove 71, so that, even if the ring button member 70 is pressurized in an inclined state, the compression groove 71 of the ring button member 70 pressurizes on the upper portion of the compression protrusion 61 of the pallet 60 so as to allow the pallet 60 to vertically pressurize the discharge device 50.

Thereafter, as the piston 55 and the piston ring 56 of the discharge device 50 coupled to a bottom of the pallet 60 are moved downward together with the pallet 60 due to the downward movement of the pallet 60, a volume inside the cylinder 51 is reduced.

Accordingly, a pressure is generated inside the cylinder 51, and the cosmetic material in the cylinder 51 tends to be discharged to the outside by the pressure, so that a discharge pressure is generated so as to allow the suction valve plate 52 to close the content suction hole 58 formed in the bottom surface of the cylinder 51.

At the same time, the cosmetic material accommodated in the cylinder 51 flows between the piston 55 and the piston ring 56, passes through the discharge passage 641 of the lower pallet 64, passes through the distribution passage 646 of the lower pallet 64, and is discharged through the discharge port 82 of the discharge plate 80.

Thereafter, when the pressurization of the ring button member 70 is released as shown in FIG. 8, the pallet 60 is moved upward by elasticity of the elastic member 54 which elastically supports the pallet 60, and the piston 55 and the piston ring 56 coupled to a bottom of the lower pallet 64 of the pallet 60 is moved upward together with the pallet 60, so that the volume inside the cylinder 51 becomes large so as to generate a vacuum pressure.

The suction valve plate 52 is lifted by the vacuum pressure generated inside the cylinder 51 so as to open the content suction hole 58 formed in the bottom surface of the cylinder 51. Accordingly, the cosmetic material accommodated in the inner container 30 is introduced into the cylinder 51 through the content suction hole 58 while the push plate 38 installed in the inner container 30 is moved upward.

As described above, although the compact container having the ring button member provided thereon and having the discharge plate formed through the insert injection molding according to one embodiment of the present invention has been described for illustrative purposes, the present invention is not limited thereto. It will be understood that various changes and modifications may be made by those skilled in the art without departing from the spirit and scope of the present invention as disclosed in the appended claims.

[Description of Reference Numerals]

| | |
|---|---|
| 10: Outer container | 16: Axial coupling groove |
| 18: Fastening groove | 20: Outer container lid |
| 30: Inner container | 40: Discharge device support |
| 50: Discharge device | 60: Pallet |
| 61: Compression protrusion | 62: Upper pallet |
| 64: Lower pallet | 70: Ring button member |
| 71: Compression groove | 73: Axial protrusion |
| 78: Fastening protrusion | 80: Discharge plate |
| 82: Discharge port | 641: Discharge passage |
| 642: Support part | 644: Seating part |
| 646: Distribution passage | 649: Mesh net |

1. A compact container having a ring button member provided thereon and having a discharge plate formed through insert injection molding, in which the compact container includes an outer container, an outer container lid hinge-coupled to one side of the outer container so as to be opened and closed, and an inner container mounted inside the outer container, the compact container comprising:
a discharge device installed in the inner container to discharge a cosmetic material;
a pallet coupled to the discharge device to pressurize the discharge device; and
a ring button member coupled to the pallet to pressurize the pallet,
wherein the pallet includes an upper pallet and a lower pallet, in which a discharge plate having a discharge port is formed between the upper pallet and the lower pallet through the insert injection molding, and
the upper pallet is insert-injection-molded while surrounding an outer side of the lower pallet such that the upper pallet and the lower pallet are fused to each other.

2. The compact container of claim 1, wherein the discharge device is a pump for pumping the cosmetic material.

3. The compact container of claim 1, wherein a support part is formed at a center of the lower pallet to make close contact with a bottom of the discharge plate.

4. The compact container of claim 1, wherein the lower pallet is provided with a seating part on which the discharge plate is seated.

5. The compact container of claim 1, wherein a distribution passage is formed in the lower pallet to allow the cosmetic material to be spread widely.

6. The compact container of claim 5, wherein a mesh net is provided on an upper portion of the distribution passage.

7. The compact container of claim 1, wherein a covering length of the upper pallet for an upper outer side of the discharge plate is 0.5 mm to 2.0 mm.

8. The compact container of claim 1, wherein a height from a top surface of the discharge plate to an inner end of the upper pallet is 0.3 mm to 1.5 mm.

9. The compact container of claim 1, wherein a height from a top surface of the discharge plate to a top surface of the upper pallet is 1.5 mm to 5.5 mm.

10. The compact container of claim 1, wherein a fusion groove is formed in a lower portion of the upper pallet, and a fusion protrusion part is provided on an upper outer side of the lower pallet, such that the fusion groove and the fusion protrusion part are fused to each other.

11. The compact container of claim 1, wherein the discharge plate is formed of a metal, an alloy of metal, or a plated metal.

12. The compact container of claim 11, wherein the discharge plate is formed of a stainless steel material among metal materials.

13. The compact container of claim 1, wherein the discharge plate is formed of a synthetic resin or a fiber material.
